(19) United States
(12) Patent Application Publication
(10) Pub. No.: US 2016/0037800 A1
(43) Pub. Date: Feb. 11, 2016

(54) CONFECTIONERY PRODUCT AND METHOD OF MAKING

(71) Applicant: Keith SPAAR, River Vale, NJ (US)

(72) Inventor: Keith SPAAR, River Vale, NJ (US)

(21) Appl. No.: 14/456,264

(22) Filed: Aug. 11, 2014

(51) Int. Cl. A23G 9/40; A23G 9/12

(52) U.S. Cl. CPC A23G 9/40; A23G 9/12; A23V 2002/00

(57) ABSTRACT

A confectionery product combines cottage cheese and yogurt blended together into a frozen product having a texture and taste similar to ice cream, but with a higher nutritional value. Fat free cottage cheese can be used to provide a lower-calorie substitute for ice cream. With the addition of a suitable sweetener and flavoring, a wide range of confections are possible. Use of artificial sweetener can further lower the caloric value of the confection.

The present invention is directed to food products, and in particular to a new and improved frozen dairy confection.

### BACKGROUND OF THE INVENTION

Frozen dairy desserts, such as ice cream and frozen yogurt, are immensely popular but often carry with them high caloric loads. While there have been advances in the field to produce variants with reduced calories, such as low-fat and low or sugar free formulations, it remains generally recognized that a healthy diet demands that such confections be eaten in moderation at best.

Cottage cheese is a milk-derived cheese curd product with a mild flavor. It is perceived as a “healthy” product, due to its relatively high protein/low fat content. Typical nutritional values for cottage cheese are as follows (per 100 g):

| | |
|---|---|
| Carbohydrates | 3.38 g |
| Sugars | 2.67 g |
| Fat | 4.30 g |
| Protein | 11.12 g |

Source—USDA—www.nal.usda.gov/fnic/foodcomp/search/

Thus, cottage cheese would seem to be a preferred starting material for frozen desserts. However, it is generally perceived that cottage cheese cannot be successfully frozen, which prevents its incorporation into such desserts. Packaging for cottage cheese itself typically contains a “do not freeze” legend.

It is accordingly the purpose of the present invention to provide a cottage cheese-based confectionery product that maintains the nutritional benefits associated with cottage cheese while offering the taste and mouth fell normally associated with conventional, higher calorie dairy confections and a method for making such a product.

### BRIEF DESCRIPTION OF THE INVENTION

Confections of the present invention are a combination of cottage cheese and yogurt, which are blended until smooth. An appropriate sweetener is added, along with a desired flavoring, and the blend then churned in a conventional manner until firm. The firm product is then frozen. The texture of the resulting product is similar to ice cream, but retains the nutritional benefits of its cottage cheese base.

### DETAILED DESCRIPTION OF THE INVENTION

A fuller understanding of the present invention will be achieved upon consideration of the following description of preferred, non-limiting illustrative embodiments of the invention.

While the present invention can incorporate a variety of cottage cheese formulations, encompassing both “regular” and “reduced fat” versions, use of low fat cheese may be preferred to further distinguish the nutritional values associated with the resulting product from conventional dairy confections. A vanilla flavor reduced fat formulation is as follows. The use of “Greek style” yogurt, in which conventional yogurt is strained to remove liquid whey, lactose and dissolved sugar, provides a formulation with increased protein content while maintaining basically the same caloric load as an otherwise similar yogurt product.

16 parts (by volume) fat free cottage cheese

16 parts fat free “Greek style” yogurt

7 parts sugar (sweetener)

0.4 parts vanilla extract (flavoring)

The cottage cheese is placed in a food processor or similar apparatus blended until smooth. The yogurt is added and blending in continued until the mixture is again smooth. At this stage the mixture should have an appearance similar to thick cream. While the mixture can be churned and cooled at this stage, it is advisable to add the sweetener and flavoring to provide a more pleasantly flavored product. Upon adding those components the mixture is further blended to combine.

The resulting confection is then transferred to an ice cream type churn for churning and cooling until set, approximately 45 minutes. The confection can then be packaged as desired and placed into a freezer for storage.

The ratio of cottage cheese to yogurt can be varied, but best results are obtained with a ratio (either by weight or by volume) at approximately 1 to 1. When a weight ratio is applied the amount of sweetener may have to be increased.

The (sweetened and flavored) confection is similar in texture and flavor to ice cream but is a healthier alternative. Acceptable sweeteners are not limited to sugars, but also include corn syrup, cane syrup, agave syrup, and honey, as well as other natural and artificial sweeteners. The precise amount to be added is a function of the desired taste sought. In a similar manner the flavoring can be any of a wide variety of natural and artificial flavorings, including syrups and extracts as well as fruits, nuts and spices. Once again, the amount to be added is primarily a function of the desired taste for the finished product. Still further, other fortifying components, such as protein powder, can be added after the blending of the cottage cheese and yogurt to enhance the nutritional benefit of the confection.

One skilled in the art will recognize that other variations and modifications are possible without departing from the inventive concept set forth herein, and the scope of the invention should not be restricted except consistent with the spirit of the disclosure.

I claim:

1. A confectionery product comprising cottage cheese and yogurt blended together into a smooth mass and frozen.

2. The confectionery product of claim 1 wherein the cottage cheese and yogurt are present in an approximately 1 to 1 ratio either by weight or by volume.

3. The confectionery product of claim 1 further comprising a sweetener and a flavoring.

4. The confectionery product of claim 1 wherein the cottage cheese in fat-free cottage cheese and the yogurt is Greek-style yogurt.

5. The confectionery product of claim 3 wherein the sweetener is sugar and is present in an approximate 0.5 to 1 ratio by volume to the cottage cheese.

6. A method for the creation of a frozen confectionery product, comprising the steps of:
blending a given volume of cottage cheese until smooth;
adding approximately an equal volume of yogurt and further blending until smooth;
optionally adding a sweetener and a flavoring and further blending until smooth; and
churning and freezing the mixture until set.

7. The method of claim 6 wherein the sweetener is added at a ratio of approximately 0.5 the volume of the cottage cheese.
